(19) United States
(12) Patent Application Publication
(10) Pub. No.: US 2026/0341608 A1
(43) Pub. Date: Oct. 29, 2026

(54) BACKLIGHT MODULE

(71) Applicant: Darfon Electronics Corp., Taoyuan City (TW)

(72) Inventors: Hsin-Cheng HO, Taoyuan City (TW); Heng-Yi HUANG, Taoyuan City (TW)

(73) Assignee: Darfon Electronics Corp., Taoyuan City (TW)

(21) Appl. No.: 19/414,386

(22) Filed: Dec. 10, 2025

Related U.S. Application Data
(63) Continuation-in-part of application No. 18/780,572, filed on Jul. 23, 2024, now Pat. No. 12,518,936.
(63) Continuation-in-part of application No. 18/221,367, filed on Jul. 12, 2023, now Pat. No. 12,596,223.
Application No. 18/780,572 is a continuation of application No. 18/398,285, filed on Dec. 28, 2023, now Pat. No. 12,154,729.
Application No. 18/398,285 is a continuation-in-part of application No. 18/297,020, filed on Apr. 7, 2023, now Pat. No. 11,881,363.
Application No. 18/297,020 is a continuation-in-part of application No. 18/127,667, filed on Mar. 29, 2023, now abandoned.
(60) Provisional application No. 63/325,623, filed on Mar. 31, 2022.
(60) Provisional application No. 63/368,272, filed on Jul. 13, 2022.
(60) Provisional application No. 63/408,062, filed on Sep. 19, 2022.
(60) Provisional application No. 63/408,069, filed on Sep. 19, 2022.
(60) Provisional application No. 63/378,261, filed on Oct. 4, 2022.
(60) Provisional application No. 63/430,675, filed on Dec. 7, 2022.
(60) Provisional application No. 63/430,675, filed on Dec. 7, 2022.
(60) Provisional application No. 63/438,254, filed on Jan. 11, 2023.
(60) Provisional application No. 63/444,573, filed on Feb. 10, 2023.
(60) Provisional application No. 63/779,424, filed on Mar. 28, 2025.

(30) Foreign Application Priority Data
Apr. 8, 2022 (TW) 111113486
Mar. 9, 2023 (TW) 112108658
Mar. 20, 2023 (TW) 112110265
Mar. 28, 2023 (TW) 112111749
May 5, 2023 (TW) 112116745
Nov. 22, 2023 (TW) 112145095
Oct. 17, 2025 (TW) 114140180

(51) Int. Cl. H01H 13/02; F21V 8/00; G06F 3/02

(52) U.S. Cl. CPC H01H 13/023; G02B 6/0035; G02B 6/0085; G06F 3/0202; H01H 2219/056; H01H 2219/06; H01H 2219/062

(57) ABSTRACT

A backlight module comprises a lighting board. The lighting board includes a reflective layer, a circuit layer and a base that are stacked from top to bottom. The reflective layer has a reflective layer hole. The lighting board includes a light-emitting unit. The light-emitting unit includes a package and a light-emitting die disposed inside the package. The reflective layer hole overlaps in projection with the light-emitting unit in a vertical direction. A projection area of the reflective layer hole in the vertical direction is smaller than a projection area of the package in the vertical direction.

This application claims the benefit of U.S. Provisional Application No. 63/779,424, filed on Mar. 28, 2025 and the benefit of Taiwan Application Ser. No. 114140180, filed on Oct. 17, 2025. Further, this application is a continuation-in-part application of U.S. application Ser. No. 18/780,572, filed on Jul. 23, 2024, which is a continuation application of U.S. application Ser. No. 18/398,285, filed on Dec. 28, 2023 (now patented as U.S. Pat. No. 12,154,729, issued Nov. 26, 2024), which claims the benefit of U.S. Provisional Application No. 63/444,573, filed on Feb. 10, 2023 and the benefit of Taiwan application Ser. No. 112145095, filed on Nov. 22, 2023. Further, this application is also a continuation-in-part application of U.S. application Ser. No. 18/221,367 filed on Jul. 12, 2023, which claims the benefit of U.S. Provisional Application No. 63/408,062, filed on Sep. 19, 2022, and claims the benefit of U.S. Provisional Application No. 63/408,069, filed on Sep. 19, 2022, and claims the benefit of Taiwan application No. 112116745, filed on May 5, 2023, and is a continuation-in-part of U.S. application Ser. No. 18/297,020, filed on Apr. 7, 2023, which claims the benefit of U.S. Provisional Application No. 63/430,675, filed on Dec. 7, 2022, and claims the benefit of U.S. Provisional Application No. 63/438,254, filed on Jan. 11, 2023, and claims the benefit of U.S. Provisional Application No. 63/368,272, filed on Jul. 13, 2022, and claims the benefit of Taiwan application No. 112111749, filed on Mar. 28, 2023, and is a continuation-in-part of U.S. application Ser. No. 18/127,667, filed on Mar. 29, 2023, which claims the benefit of U.S. Provisional Application No. 63/325,623, filed on Mar. 31, 2022, and claims the benefit of U.S. Provisional Application No. 63/430,675, filed on Dec. 7, 2022, and claims the benefit of U.S. Provisional Application No. 63/378,261, filed on Oct. 4, 2022 and claims the benefit of Taiwan application Ser. No. 111113486, filed on Apr. 8, 2022, and claims the benefit of Taiwan application No. 112108658, filed on Mar. 9, 2023, and claims the benefit of Taiwan application No. 112110265, filed on Mar. 20, 2023. The contents of these applications are incorporated herein by reference.

### FIELD OF THE INVENTION

The invention relates to a backlight module.

### DESCRIPTION OF THE PRIOR ART

As technology advances, there are many types of keyboards in use. Users pay much more attention to visual effect of keyboard except basic input function while choosing keyboard. So far a lighting keyboard has been developed. The lighting keyboard attracts users in visual effect and can be used in darkness. When a conventional luminous keyboard is used in a thin computing device, a large number of components are stacked in a small space of the computing device, thereby raising a prominent heat dissipation problem. Thus, there is a need to improve lighting efficiency of the lighting keyboard, and a backlight module embedded it need to be correspondingly adjusted as well.

### SUMMARY OF THE INVENTION

The invention is directed to provide a backlight module that is able to enhance the lighting efficiency.

According to a first aspect of the invention, a backlight module comprises a lighting board. The lighting board includes a reflective layer, a circuit layer and a base that are stacked from top to bottom. The reflective layer has a reflective layer hole. The lighting board includes a light-emitting unit. The light-emitting unit includes a package and a light-emitting die disposed inside the package. The reflective layer hole overlaps in projection with the light-emitting unit in a vertical direction. A projection area of the reflective layer hole in the vertical direction is smaller than a projection area of the package in the vertical direction.

According to a second aspect of the invention, a backlight module comprises a lighting board. The lighting board includes a reflective layer, a circuit layer and a base that are stacked from top to bottom. The reflective layer has a first reflective layer hole and a second reflective layer hole. The lighting board includes a light-emitting unit. The light-emitting unit includes a package and a light-emitting die disposed inside the package. The first reflective layer hole and the first reflective layer holes overlap in projection with the light-emitting unit in a vertical direction. A projection area of the reflective layer hole in the vertical direction and a projection area of the reflective layer hole in the vertical direction are respectively smaller than a projection area of the package in the vertical direction.

According to a third aspect of the invention, a backlight module comprises a lighting board. The lighting board includes a reflective layer, a circuit layer and a base that are stacked from top to bottom. The reflective layer has a reflective layer hole. A reflective surface with light-reflecting property is formed on an upper surface of the base. The reflective surface is exposed through the reflective layer hole. The lighting board includes a light-emitting unit. The light-emitting unit includes a package and a light-emitting die disposed inside the package. The light-emitting unit hole overlaps in projection with the reflective layer in a vertical direction. A projection area of the package in the vertical direction is smaller than a projection area of the reflective layer hole in the vertical direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a lighting keyboard according to an embodiment of the invention.

FIG. 2 is a partial sectional view illustrating the lighting keyboard shown in FIG. 1.

FIG. 3A is a partial exploded view illustrating a configuration of the lighting keyboard shown in FIG. 1.

FIG. 3B is a partial exploded view illustrating another configuration of the lighting keyboard shown in FIG. 1.

FIG. 4 is a partial top view illustrating the lighting keyboard shown in FIG. 1.

FIG. 5A is a partial top view illustrating a configuration of the lighting keyboard shown in FIG. 1.

FIG. 5B is a partial top view illustrating another configuration of the lighting keyboard shown in FIG. 1.

FIG. 6A is a partial top view illustrating a configuration of the lighting keyboard shown in FIG. 1.

FIG. 6B is a partial top view illustrating another configuration of the lighting keyboard shown in FIG. 1.

FIG. 7A is a partial top view illustrating a backlight module of a lighting keyboard according to an embodiment of the invention.

FIG. 7B is a top view illustrating the backlight module shown in FIG. 7A.

FIG. 7C is a top view illustrating a lighting board of the backlight in module shown in FIG. 7A.

FIG. 8A is a partial top view illustrating a backlight module of a lighting keyboard according to an embodiment of the invention.

FIG. 8B is a top view illustrating the backlight module shown in FIG. 8A.

FIG. 8C is a top view illustrating a lighting board of the backlight module shown in FIG. 8A.

FIG. 9A is a partial top view illustrating a backlight module of a lighting keyboard according to an embodiment of the invention.

FIG. 9B is a top view illustrating the backlight module shown in FIG. 9A.

FIG. 9C is a top view illustrating a lighting board of the backlight module shown in FIG. 9A.

FIG. 10A is a partial top view illustrating a backlight module of a lighting keyboard according to an embodiment of the invention.

FIG. 10B is a top view illustrating the backlight module shown in FIG. 10A.

FIG. 10C is a top view illustrating a lighting board of the backlight module shown in FIG. 10A.

### DETAILED DESCRIPTION

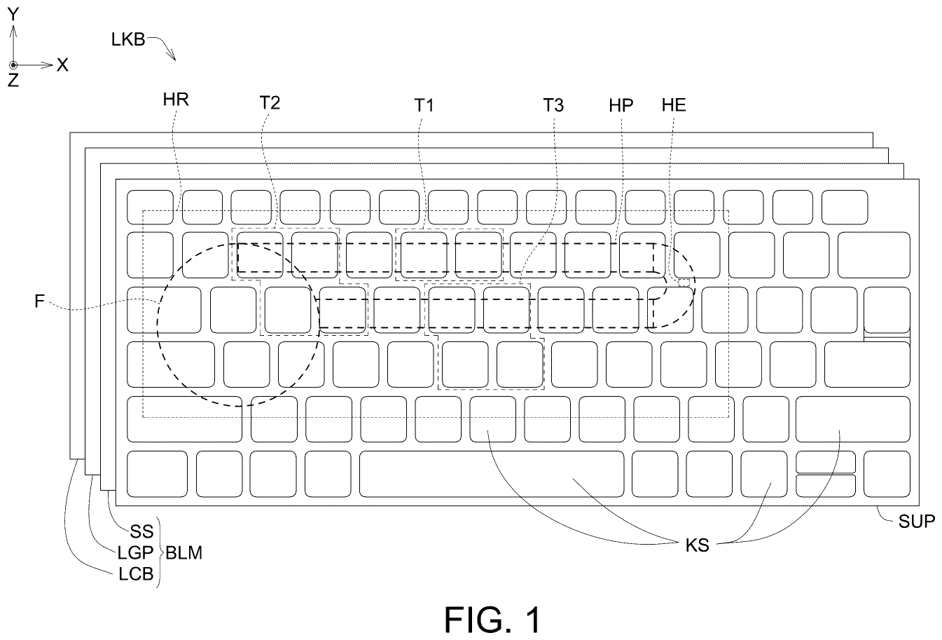

Referring to FIG. 1, FIG. 1 is a schematic view illustrating a lighting keyboard LKB according to an embodiment of the invention.

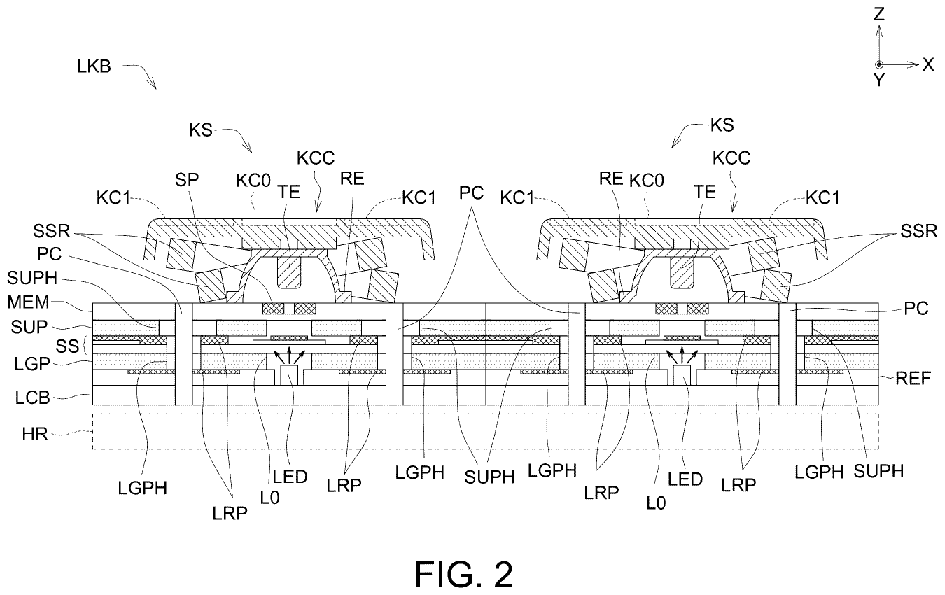

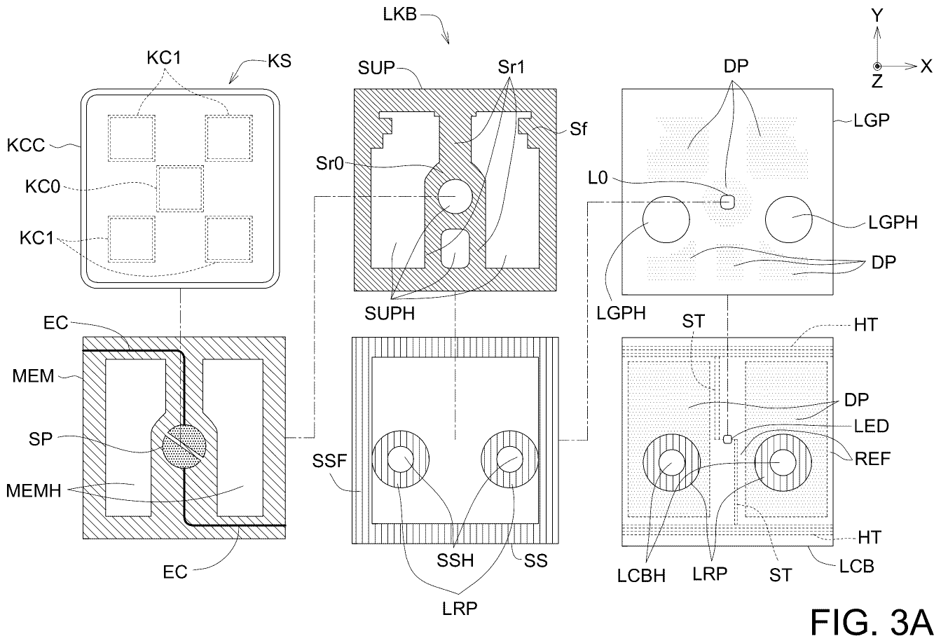

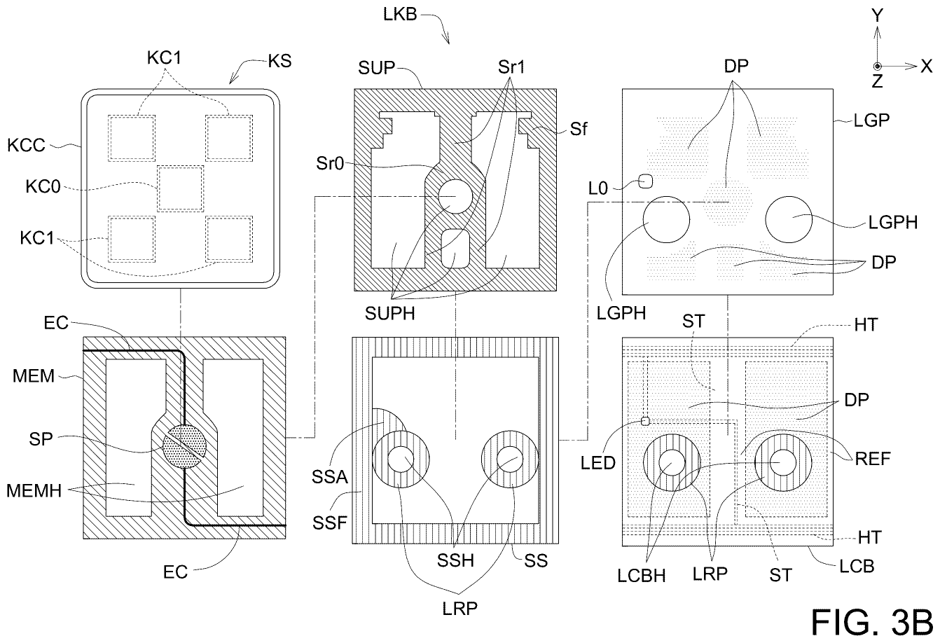

As shown in FIG. 1, there are a heating element HE (e.g. integrated circuit or electronic element), a fan F and a heat pipe HP below the lighting keyboard LKB. Heat dissipation are needed at a heat region HR where the heating element HE, the fan F and the heat pipe HP overlap with the lighting keyboard LKB. The lighting keyboard LKB comprises a backlight module BLM and a plurality of heat-dissipating keys KS. A support plate SUP is disposed on the backlight module BLM and the heat-dissipating keys KS are disposed on the support plate SUP. In general, the heat-dissipating keys KS may comprise square keys and multiple keys (e.g. space key). It should be noted that the number, size and arrangement of the heat-dissipating keys KS may be determined according to practical applications, so the invention is not limited to the embodiment shown in the figure. The backlight module BLM comprises a lighting board LCB, a light guide panel LGP and a shielding sheet SS. The light guide panel LGP is configured in optical communication with at least one light-emitting unit LED on the lighting board LCB, as shown in FIG. 2 and FIG. 3.

The lighting board LCB, the light guide panel LGP and the shielding sheet SS are stacked up and down (or may be referred to as stacked vertically), namely the light guide panel LGP is disposed on the lighting board LCB and the shielding sheet SS is disposed on the light guide panel LGP.

Further referring to FIGS. 2 to 3B, FIG. 2 is a partial sectional view illustrating the lighting keyboard LKB shown in FIG. 1, FIG. 3A is an exploded view illustrating layers of a single heat-dissipating key KS of the lighting keyboard LKB shown in FIG. 1, and FIG. 3B is an exploded view illustrating layers of another single heat-dissipating key KS of the lighting keyboard LKB shown in FIG. 1, wherein a support mechanism SSR, a trigger element TE and a restoration member RE are omitted in FIGS. 3A and 3B.

In this embodiment, each heat-dissipating key KS on the lighting keyboard LKB corresponds to at least one light-emitting unit (e.g. LED) on the lighting board LCB of the backlight module BLM. In other possible embodiments, each heat-dissipating key KS on the lighting keyboard LKB corresponds to a light bar on the lighting board LCB of the backlight module BLM. The backlight module BLM may have a plurality of penetration channels PC symmetrically to correspond to the heat-dissipating keys KS respectively, so as to allow hot air and cold air to flow and exchange through penetration channels PC. The penetration channels PC penetrate the lighting board LCB, the light guide panel LGP and the shielding sheet SS. When the lighting board LCB is a small-sized light bar, the penetration channels PC may not be able to penetrate the lighting board LCB. In such case, the penetration channels PC penetrate the shielding sheet SS, the light guide panel LGP and a reflective layer REF on top of the light bar functioning as the lighting board LCB. As shown in FIG. 2, two penetration channels PC are provided below a single heat-dissipating key KS, but the invention is not so limited. The penetration channels PC also penetrate the key circuit board MEM, the support plate SUP and a reflective layer REF. That is to say, the penetration channel PC is formed by stacking the perforations of layers of the key circuit board MEM, the support plate SUP, the shielding sheet SS, the light guide panel LGP, the reflective layer REF and the lighting board LCB in the Z direction, wherein these perforations at least partially overlaps one another. The perforation of the light guide panel LGP can be larger than the perforations of the reflective layer REF and the shielding sheet SS. The penetration channels PC are configured to be heat-dissipating channels for the heat region HR.

The heat-dissipating key KS comprises a keycap KCC, the support mechanism SSR, the key circuit board MEM and the support plate SUP. The keycap KCC is disposed with respect to the support plate SUP. The keycap KCC has an inner outlet KC0, such that the light emitted by a light-emitting unit LED may be projected from the inner outlet KC0 to illuminate the character on the keycap KCC. The keycap KCC further has a plurality of outer outlets KC1 being adjacent to the inner outlet KC0. As shown in FIG. 2, the positions of the outer outlets KC1 correspond to the positions of the penetration channels PC, such that the penetration channels PC can be disposed below an opaque area, thereby reducing the upward light leakage. The support mechanism SSR is disposed between the keycap KCC and the support plate SUP. When the keycap KCC is pressed, the keycap KCC will move vertically toward the support plate SUP along with the support mechanism SSR. Furthermore, the restoration member RE may be further disposed between the keycap KCC and the support plate SUP, wherein the restoration member RE may be, but is not limited to, a rubber dome. The keycap KCC, the support mechanism SSR, the restoration member RE, the key circuit board MEM and the support plate SUP may be mainly formed by a non-reflective or low-reflective material or a light-absorbing material, thereby reducing the downward light reflection.

The key circuit board MEM is disposed above the backlight module BLM. Furthermore, a switch pad SP corresponding to the trigger element TE of the heat-dissipating key KS may be provided on the key circuit board MEM, wherein the switch pad SP may be, but is not limited to, a membrane switch. In this embodiment, the key circuit board MEM comprises an electric circuit portion EC, a plurality of membrane holes MEMH and the switch pad SP. The membrane hole MEMH constitutes a part of the penetration channel PC. The switch pad SP is connected to the electric circuit portion EC and is located between the membrane holes MEMH. Furthermore, the key circuit board MEM can be coated with a light-absorbing material around the penetration channel PC, thereby reducing the upward light leakage.

Each of the heat-dissipating keys KS comprises a part of the support plate SUP. In this embodiment, the support plate SUP may include a surrounding rib Sr0, a plurality of bridge ribs Sr1 and a support frame Sf, wherein the bridge ribs Sr1 connect the surrounding rib Sr0 and the support frame Sf, and there are a plurality of support plate holes SUPH between the bridge ribs Sr1, the surrounding rib Sr0 and the support frame Sf. The support plate holes SUPH on two sides are a part of the penetration channel PC. The switch pad SP of the key circuit board MEM is disposed with respect to a support plate hole SUPH in the center of the support plate SUP, such that the switch pad SP may partially enter the support plate hole SUPH in the center of the support plate SUP without interfering with the shielding sheet SS and the light-emitting unit LED below the shielding sheet SS.

The shielding sheet SS is disposed below the support plate SUP. In this embodiment, the shielding sheet SS has a plurality of shielding sheet holes SSH, a plurality of light-reducing patterns LRP and a shielding frame SSF, with the rest of the shielding sheet SS remaining a rectangular light permeable area surrounded by the shielding frame SSF.

In an embodiment, as shown in FIG. 3B, the shielding frame SSF may extend inward to form a shielding area SSA. The shielding area SSA is located at a position corresponding to that of the light-emitting unit LED in the Z direction, so as to provide a light-shielding function for adjusting a light-emitting effect of the light-emitting unit LED, thereby serving as a light source mask. The shielding area SSA is arranged particularly for a condition in which the light-emitting unit LED is not aligned with the shielding frame SSF, that is, when a region above the light-emitting unit LED is not covered by the shielding frame SSF. If the light-emitting unit LED overlaps in projection with the shielding frame SSF in the Z direction, the shielding area SSA may be omitted. The rectangular light permeable area has four corners corresponding to the four corners of shielding frame SSF and to the four corners of the keycap KCC. The light permeable area allow light to pass through upwards and illuminate the keycap KCC. The shielding sheet holes SSH are respectively located in the light-reducing patterns LRP, and the shielding frame SSF corresponds to the support frame Sf of the support plate SUP. The shielding sheet hole SSH constitutes a part of the penetration channel PC. The light-reducing pattern LRP of the shielding sheet SS is provided at periphery of each penetration channel PC for blocking light. The light-reducing pattern LRP can be a ring-shaped black ink being coated on the top surface and/or the bottom surface of the shielding sheet SS.

The light guide panel LGP is disposed below the shielding sheet SS. In this embodiment, the light guide panel LGP has a light guide hole L0, a plurality of light guide panel holes LGPH and a plurality of diffusion patterns DP. The light-emitting unit LED is located in the light guide hole L0. The top surface and/or the bottom surface of the light guide panel LGP close to the light guide hole L0 may have adhesive around the light guide hole L0 to adhere the shielding sheet SS and/or the lighting board LCB respectively. The position of the light guide panel hole LGPH corresponds to the position of the shielding sheet holes SSH and constitutes a part of the penetration channel PC. The diffusion patterns DP may be formed by microstructure regions, and the positions thereof correspond to the positions of the support plate holes SUPH, and the light permeable area of shielding sheet SS so as to guide the light transmitted in the light guide panel LGP to emit out upward. From top view in the Z direction, the diffusion patterns DP of the light guide panel LGP can be provided near the light-reducing pattern LRP of the shielding sheet SS to guide the light of the light-emitting unit LED to illuminate the corresponding heat-dissipating key KS. The diffusion patterns DP of the light guide panel LGP each is configured at a position corresponding to the four corners of shielding frame SSF, the four corners of the light permeable area of shielding sheet SS, and corresponding to the four corners of the keycap KCC, thereby facilitating the light uniformity along the peripheral of keycap KCC, including four edges and four corners. Furthermore, either realizing the light-reducing pattern LRP by a ring-shaped black ink coated on the top surface or the bottom surface of the light guide panel LGP at periphery of the penetration channel PC, or coating a light-absorbing material on the hole wall of the light guide panel hole LGPH, or providing adhesive on the top surface and the bottom surface of the light guide panel hole LGPH near periphery of the penetration channel PC can all reduce the upward or downward light leaking from the light guide panel LGP in the penetration channel PC.

The lighting board LCB is disposed below the light guide panel LGP and may include the reflective layer REF on top of the lighting board LCB. In this embodiment, the lighting board LCB comprises the light-emitting unit LED, a plurality of lighting board holes LCBH, a plurality of light-reducing patterns LRP, a plurality of diffusion patterns DP, a plurality of main traces HT and a plurality of sub-traces ST. As shown in FIG. 3A, the light-emitting unit LED may be aligned with a central position of the keycap KCC of the heat-dissipating key KS in the Z direction, and be located between two diffusion patterns DP of the lighting board LCB. Alternatively, in another embodiment, as shown in FIG. 3B, the light-emitting unit LED may not be aligned with the central position of the keycap KCC of the heat-dissipating key KS in the Z direction, but may overlap with a diffusion pattern DP of the lighting board LCB in the Z direction, and be located at a position adjacent to an edge of the keycap KCC. The light-reducing patterns LRP may be realized on the top surface of lighting board LCB, or on the top surface of reflective layer REF, especially when lighting board LCB is a small-sized light bar. The light-emitting unit LED is connected between two sub-traces ST, and the light-emitting unit LED is connected between two main traces HT through the two sub-traces ST. In this embodiment, the main traces HT and the sub-traces ST constitute the lighting circuit of the light-emitting unit LED, the main trace HT may be a main drive trace, and the sub-trace ST may be a sub-drive trace. The light-emitting unit LED may be a white LED or a combination of RGB LEDs according to practical applications. In general, the main trace HT has a larger cross-sectional area and may cross a plurality of heat-dissipating keys KS. The position of the lighting board hole LCBH corresponds to the positions of the light guide panel hole LGPH and the shielding sheet holes SSH, and constitutes a part of the penetration channel PC. The light-reducing pattern LRP can be a ring-shaped black ink being formed in the reflective layer REF to be disposed at periphery of the penetration channel PC. The diffusion patterns DP may also be formed by the microstructure regions and can be formed in the reflective layer REF, and the diffusion patterns DP are disposed near the light-reducing pattern LRP, so as to guide the light of the light-emitting unit LED to illuminate the corresponding heat-dissipating key KS. The diffusion patterns may be formed on the light guide panel LGP and/or the lighting board LCB.

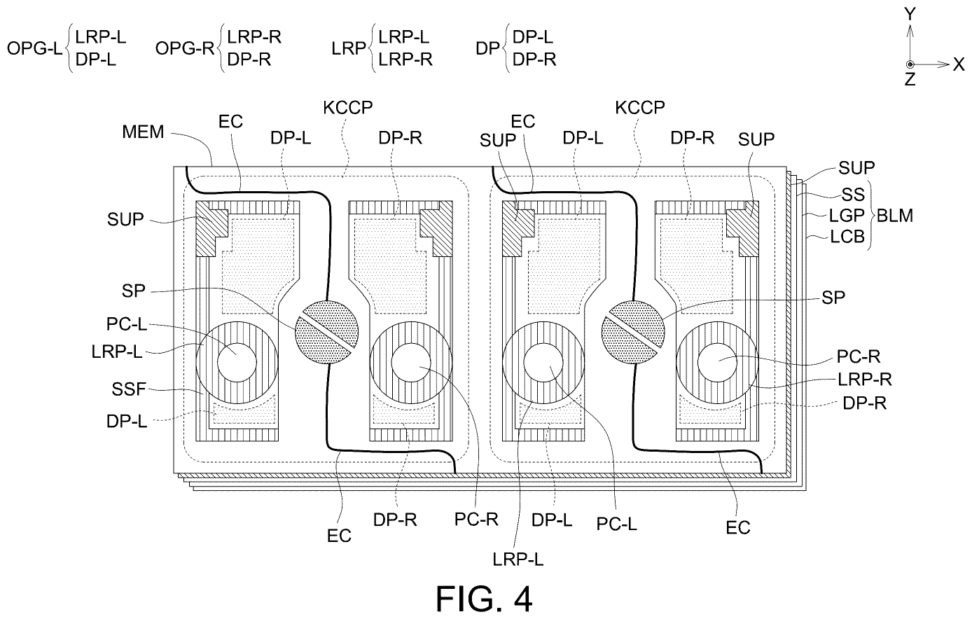

Further referring to FIG. 4, FIG. 4 is a top view illustrating a partial region T1 of the lighting keyboard LKB shown in FIG. 1, wherein the keycap KCC, the support mechanism SSR, the trigger element TE and the restoration member RE are omitted in FIG. 4.

Two heat-dissipating keys KS in the partial region T1 respectively have a keycap projected area KCCP of the keycap KCC, and each electric circuit portion of the key circuit board MEM extends across a range of the keycap projected area KCCP. Moreover, as shown in FIGS. 3 and 4, a rib portion (comprising the surrounding rib Sr0 and the bridge ribs Sr1) of the support plate SUP extends across the range of the keycap projected area KCCP. Corresponding to a single heat-dissipating keys KS, the penetration channel PC may include a left penetration channel PC-L and a right penetration channel PC-R. Two left penetration channels PC-L symmetrically correspond to two heat-dissipating keys KS and penetrate the lighting board LCB, the light guide panel LGP and the shielding sheet SS. Two right penetration channels PC-R also symmetrically correspond to the two heat-dissipating keys KS and penetrate the lighting board LCB, light guide panel LGP and shielding sheeting SS. Each of the two left penetration channels PC-L is provided with a left light-reducing pattern LRP-L at their periphery. Two left diffusion patterns DP-L are provided on the upper side and the lower side of each left light-reducing pattern LRP-L. Each of the two right penetration channels PC-R is provided with a right light-reducing pattern LRP-R at its periphery. Two right diffusion patterns DP-R are provided on the upper side and the lower side of each right light-reducing pattern LRP-R. That is, the light-reducing pattern LRP may include the left light-reducing pattern LRP-L and the right light-reducing pattern LRP-R to correspond to a single heat-dissipating key KS, and the diffusion pattern DP may include the left diffusion pattern DP-L and the right diffusion pattern DP-R to correspond to a single heat-dissipating key KS. Two diffusion patterns DP are provided near each of light-reducing patterns LRP. From top view in the Z direction, each of the light-reducing patterns LRP is located between two adjacent diffusion patterns DP.

The left light-reducing pattern LRP-L and the left diffusion pattern DP-L may constitute a left heat-reducing optical pattern group OPG-L, and the right light-reducing pattern LRP-R and the right diffusion pattern DP-R may constitute a right heat-reducing optical pattern group OPG-R. In this embodiment, the backlight module BLM has two penetration channels PC (i.e. one left penetration channel PC-L and one right penetration channel PC-R) to correspond to each heat-dissipating key KS. The left heat-reducing optical pattern group OPG-L and the right heat-reducing optical pattern group OPG-R, corresponding to each heat-dissipating key KS, are symmetrically located on opposite sides of each keycap projected area KCCP. In this embodiment, the two left heat-reducing optical pattern groups OPG-L corresponding to the two heat-dissipating keys KS have identical patterns, and the two right heat-reducing optical pattern groups OPG-R corresponding to the two heat-dissipating keys KS also have identical patterns. In practical applications, the electric circuit portion EC of the key circuit board MEM board of a square key may not be light-transparent and is not suitable to be above the diffusion pattern DP, so a longitudinal extending part of the electric circuit portion EC is preferably located between the left heat-reducing optical pattern group OPG-L and the right heat-reducing optical pattern group OPG-R corresponding to a single heat-dissipating key KS.

In practical applications, the rib portion (comprising the surrounding rib Sr0 and the bridge ribs Sr1) of the support plate SUP of a square key may not be light-transparent and is not suitable to be above the diffusion pattern DP, so the surrounding rib Sr0 and the bridge ribs Sr1 of the support plate SUP are preferably located between the left heat-reducing optical pattern group OPG-L and the right heat-reducing optical pattern group OPG-R corresponding to a single heat-dissipating key KS. That is, from top view in the Z direction, the left light-reducing pattern LRP-L and the left diffusion pattern DP-L are located on the same side of the electric circuit portion EC and on the same side of the rib portion (comprising the surrounding rib Sr0 and the bridge ribs Sr1) of the support plate SUP; the right light-reducing pattern LRP-R and the right diffusion pattern DP-R are located on the same side of the electric circuit portion EC and on the same side of the rib portion (comprising the surrounding rib Sr0 and the bridge ribs Sr1) of the support plate SUP. Moreover, from top view in the Z direction, the left light-reducing pattern LRP-L and the right light-reducing pattern LRP-R are located on opposite sides of the electric circuit portion EC and on opposite sides of the rib portion (comprising the surrounding rib Sr0 and the bridge ribs Sr1) of the support plate SUP; the left diffusion pattern DP-L and the right diffusion pattern DP-R are located on opposite sides of the electric circuit portion EC and on opposite sides of the rib portion (comprising the surrounding rib Sr0 and the bridge ribs Sr1) of the support plate SUP.

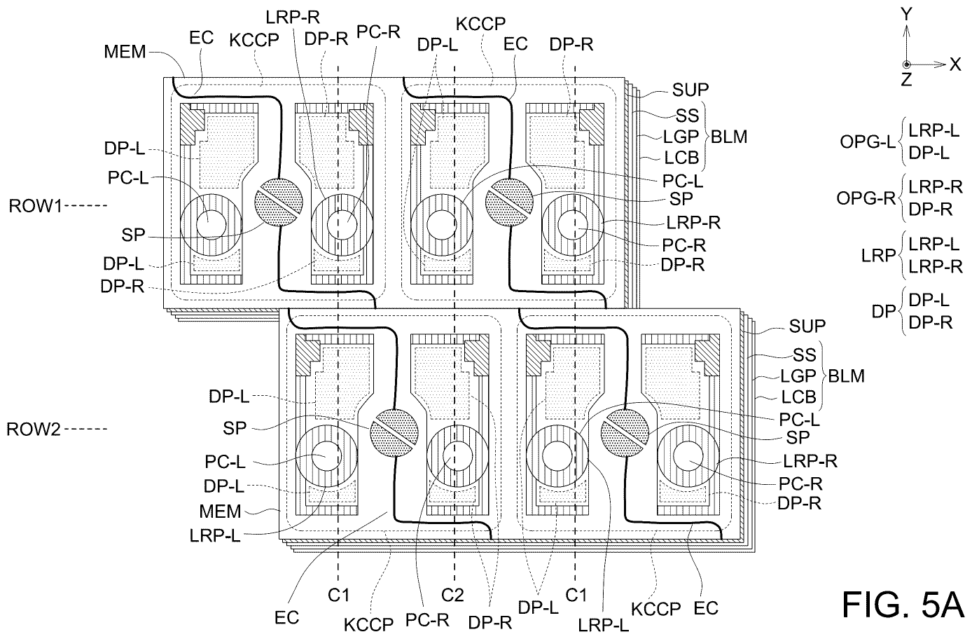

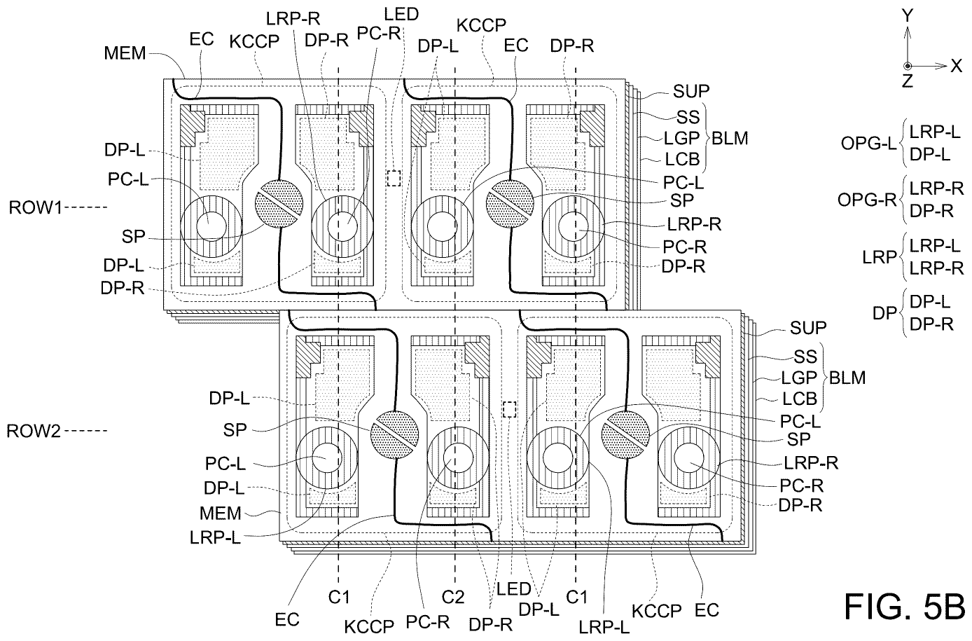

Further referring to FIGS. 5A to 5B, FIG. 5A is a top view illustrating a partial region T2 of the lighting keyboard LKB shown in FIG. 1, FIG. 5B is a top view illustrating a feasible configuration of the partial region T2 of the lighting keyboard LKB of FIG. 1, and wherein the keycap KCC, the support mechanism SSR, the trigger element TE and the restoration member RE are omitted in FIGS. 5A and 5B. The four heat-dissipating keys KS in the partial area T2 can also have all the features described above, which will not repeated herein. The description regarding FIGS. 5A and 5B mainly focus on the features of the heat-dissipating keys KS in different rows of the lighting keyboard LKB.

As shown in FIGS. 5A and 5B, the heat-dissipating key KS located on the left side of an top row ROW1 and the heat-dissipating key KS located on the left side of a middle row ROW2 are adjacent in the Y direction but not aligned in the X direction; the heat-dissipating key KS located on the right side of the top row ROW1 and the heat-dissipating key KS located on the right side of the middle row ROW2 are adjacent in the Y direction but is not aligned in the X direction. The right heat-reducing optical pattern group OPG-R (constituted by the right light-reducing pattern LRP-R and the right diffusion pattern DP-R) corresponding to the heat-dissipating key KS located on the left side of the top row ROW1 at least partially overlaps the left heat-reducing optical pattern group OPG-L (constituted by the left light-reducing pattern LRP-L and the left diffusion pattern DP-L) of the heat-dissipating key KS located on the left side of the middle row ROW2 in the Y direction. That is, these two partially overlapping heat-reducing optical pattern groups form an alignment line C1. Furthermore, the right heat-reducing optical pattern group OPG-R (constituted by the right light-reducing pattern LRP-R and the right diffusion pattern DP-R) corresponding to the heat-dissipating key KS located on the right side of the top row ROW1 at least partially overlaps the left heat-reducing optical pattern group OPG-L (constituted by the left light-reducing pattern LRP-L and the left diffusion pattern DP-L) of the heat-dissipating key KS located on the right side of the middle row ROW2 in the Y direction. That is, these two partially overlapping heat-reducing optical pattern groups also form the alignment line C1.

Furthermore, the left heat-reducing optical pattern group OPG-L (constituted by the left light-reducing pattern LRP-L and the left diffusion pattern DP-L) corresponding to the heat-dissipating key KS located on the right side of the top row ROW1 at least partially overlaps the right heat-reducing optical pattern group OPG-R (constituted by the right light-reducing pattern LRP-R and the right diffusion pattern DP-R) of the heat-dissipating key KS located on the left side of the middle row ROW2 in the Y direction. That is, these two partially overlapping heat-reducing optical pattern groups form an alignment line C2. In brief, the alignment line C1 is formed by the right heat-reducing optical pattern group OPG-R of a higher row and the right heat-reducing optical pattern group OPG-R of a lower row, which correspond to two heat-dissipating keys KS being adjacent in the Y direction but not aligned in the X direction; the alignment line C2 is formed by the left heat-reducing optical pattern group OPG-L of a higher row and the right heat-reducing optical pattern group OPG-R of a lower row, which correspond to the two heat-dissipating keys KS that are adjacent in the Y direction but misaligned in the X direction. FIGS. 5A and 5B show a special arrangement in which the heat-dissipating keys KS of two adjacent rows in the lighting keyboard LKB are offset by ½ of the key center. Furthermore, as shown in FIG. 5B, in a condition that the light-emitting unit LED is not installed on the lighting board LCB in a protruding manner, it is unnecessary to consider the possibility of interference between the light-emitting unit LED and the support plate SUP in the Z direction. Accordingly, the light-emitting unit LED may be disposed between two adjacent keycaps KCC, namely at a position between the keycap projected areas KCCP.

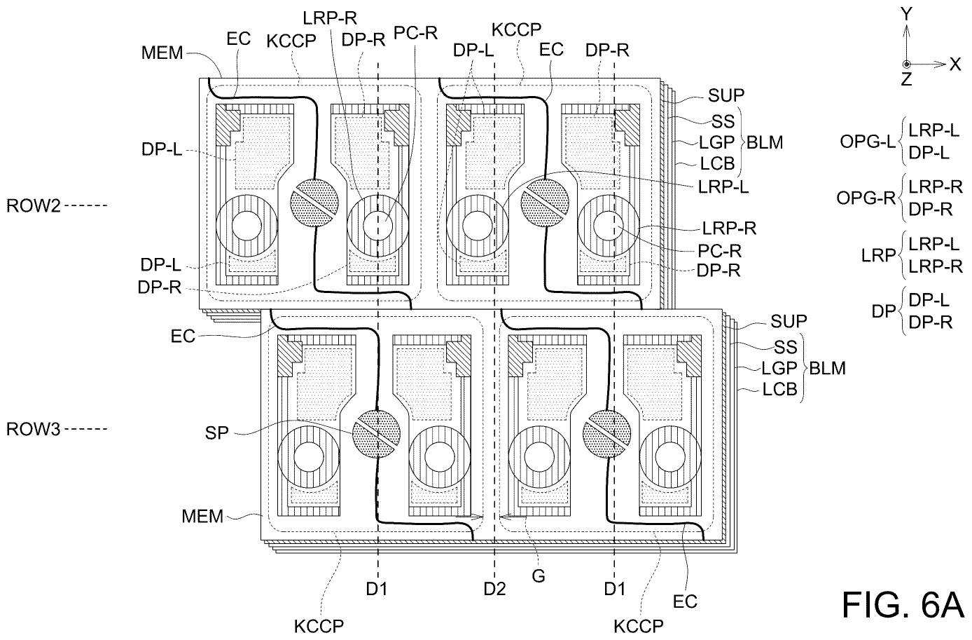

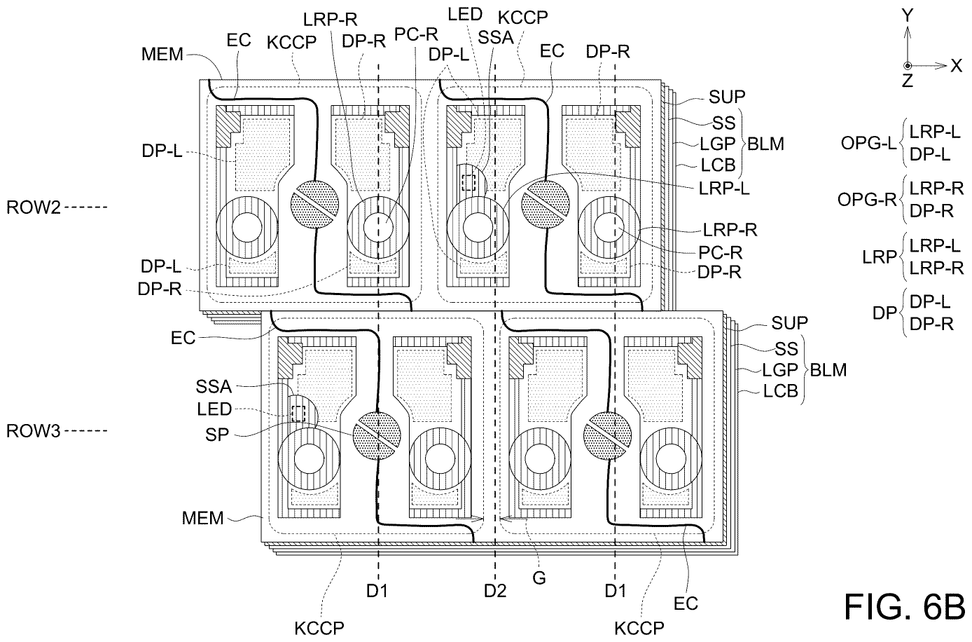

Further referring to FIGS. 6A to 6B, FIG. 6A is a top view illustrating a partial region T3 of the lighting keyboard LKB shown in FIG. 1, FIG. 6B is a top view illustrating a feasible configuration of the partial region T3 of the lighting keyboard LKB of FIG. 1, and wherein the keycap KCC, the support mechanism SSR, the trigger element TE and the restoration member RE are omitted in FIGS. 6A and 6B. The four heat-dissipating keys KS in the partial area T3 can also have all the features described above, which will not repeated herein. The description regarding FIGS. 6A and 6B mainly focus on the features of the heat-dissipating keys KS in different rows of the lighting keyboard LKB.

As shown in FIGS. 6A and 6B, the heat-dissipating key KS located on the left side of the middle row ROW2 and the heat-dissipating key KS located on the left side of a bottom row ROW3 are adjacent in the Y direction but not aligned in the X direction; the heat-dissipating key KS located on the right side of the middle row ROW2 and the heat-dissipating key KS located on the right side of the bottom row ROW3 are adjacent in the Y direction but is not aligned in the X direction. The right heat-reducing optical pattern group OPG-R (constituted by the right light-reducing pattern LRP-R and the right diffusion pattern DP-R) corresponding to the heat-dissipating key KS located on the left side of the middle row ROW2 at least partially overlaps the switch pad SP corresponding to the heat-dissipating key KS located on the left side of the bottom row ROW3 in the Y direction. That is, this right heat-reducing optical pattern group and this switch pad SP that partially overlap each other form an alignment line D1. Moreover, the right heat-reducing optical pattern group OPG-R (constituted by the right light-reducing pattern LRP-R and the right diffusion pattern DP-R) corresponding to the heat-dissipating key KS located on the right side of the middle row ROW2 at least partially overlaps the switch pad SP corresponding to the heat-dissipating key KS located on the right side of the bottom row ROW3 in the Y direction. That is, this right heat-reducing optical pattern group and this switch pad SP that partially overlap each other also form the alignment line D1.

Furthermore, the left heat-reducing optical pattern group OPG-L (constituted by the left light-reducing pattern LRP-L and the left diffusion pattern DP-L) corresponding to the heat-dissipating key KS located on the right side of the middle row ROW2 at least partially overlaps a gap region G exterior to the heat-dissipating keys located on the left side or the right side of the bottom row ROW3 in the Y direction. That is, this left heat-reducing optical pattern group and this gap region G that partially overlap each other also form an alignment line D2. In brief, the alignment line D1 is formed by the right heat-reducing optical pattern group OPG-R of a higher row and a switch pad SP of a lower row, which correspond to two heat-dissipating keys KS being adjacent in the Y direction but not aligned in the X direction; the alignment line D2 is formed by the left heat-reducing optical pattern group OPG-L of a higher row and a gap region G of a lower row, which correspond to the two heat-dissipating keys KS that are adjacent in the Y direction but misaligned in the X direction. FIGS. 6A and 6B show a special arrangement in which the heat-dissipating keys KS of two adjacent rows in the lighting keyboard LKB are offset by ¼ of the key center. Furthermore, as shown in FIG. 6B, in a condition that the light-emitting unit LED is installed on the lighting board LCB in a protruding manner, it is necessary to consider the potential interference between the light-emitting unit LED and the support plate SUP in the Z direction. Therefore, the position of the light-emitting unit LED needs to correspond to the support plate hole SUPH (shown in FIG. 3B) and the membrane hole MEMH (shown in FIG. 3B). Since the position corresponding to the support plate hole SUPH and the membrane hole MEMH is not shielded by the shielding frame SSF of the shielding sheet SS, the shielding sheet SS needs to be provided with a shielding area SSA as described above.

As mentioned in the above, the invention makes at least one penetration channel on the lighting keyboard and the backlight module therefor. Accordingly, the through-channel can be configured to dissipate heat in the heat region under the heat-dissipating keys, thereby improving the heat dissipation efficiency of the lighting keyboard. Furthermore, the present invention also makes a light-reducing pattern at periphery of the penetration channel to block light and adjacent diffusion patterns for guiding the light to illuminate the heat-dissipating key, so as to enhance the overall illuminating consistency and to solve the problem of the upward or downward light leakage in the penetration channel.

On the other hand, the backlight module of the lighting keyboard according to embodiments of the present invention may be further designed and adjusted with respect to the configuration of the reflective layer of its lighting board, so as to improve the light-emitting efficiency of the lighting keyboard. Therefore, the technical features of the following embodiments described in the present disclosure focus on various feasible embodiments between the light-emitting unit and the lighting board of the backlight module.

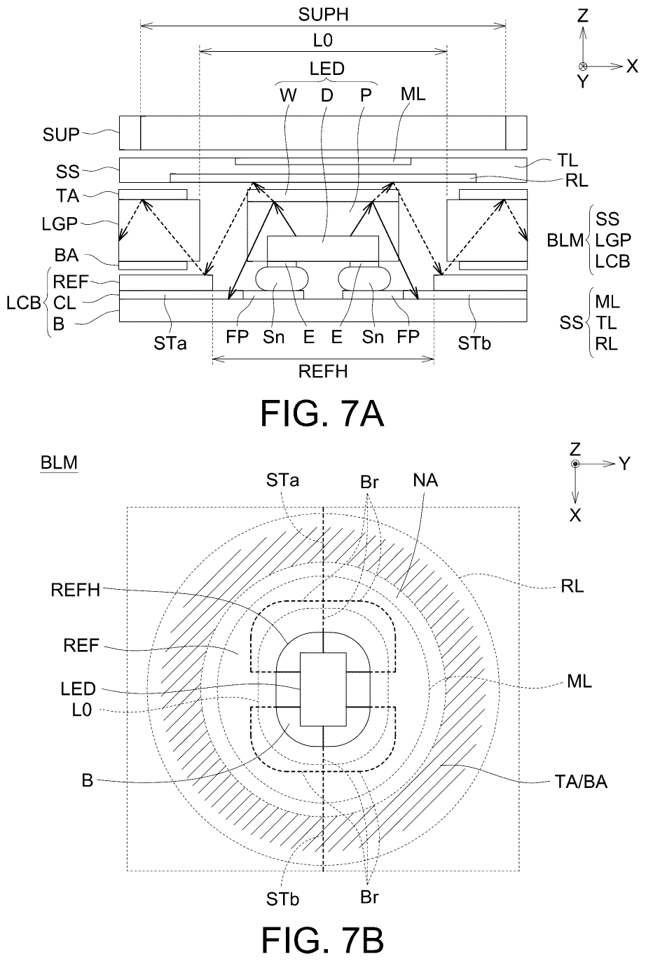

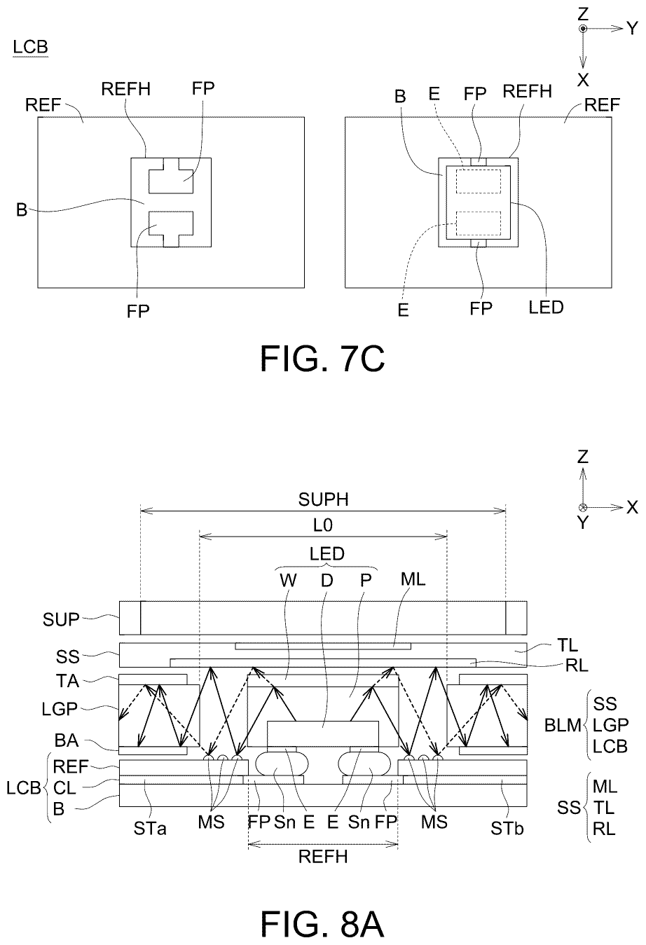

Please refer to FIGS. 7A to 7C. FIG. 7A is a partial top view illustrating one embodiment of a backlight module BLM of the lighting keyboard LKB of the present invention. FIG. 7B is a top view of the backlight module BLM in FIG. 7A, and FIG. 7C is a top view illustrating the lighting board LCB of the backlight module BLM of FIG. 7A. The left and right portions of FIG. 7C respectively illustrate the distinction between the presence and absence of the light-emitting unit LED.

As shown in FIGS. 7A to 7C, the lighting board LCB of the backlight module BLM includes a reflective layer REF, a circuit layer CL, and a base B. The reflective layer REF, the circuit layer CL and the base B are stacked from top to bottom, where the circuit layer CL is disposed on the base B, and the reflective layer REF is disposed on the circuit layer CL. The circuit layer CL includes two sub-traces STa and STb, and there is a footprint FP at the end of each of the two sub-traces STa/STb. Each footprint FP may be integrally formed with the sub-traces STa/STb by printing conductive wires or integrally formed with the sub-traces STa/STb by copper foil base etching process. However, each footprint FP may also be formed by overmolding process, or made of different material from that of the sub-traces STa/STb. As shown in FIG. 7B, each footprint FP has three branches Br, wherein the middle branch Br extends straight outward from a intersection point of the three branches Br (which overlaps in projection with the light-emitting unit LED vertically) to connect the sub-traces STa/STb. The remaining left and right two branches Br extend outward to form L-shaped paths to connect the sub-traces STa/STb.

The lighting board LCB is provided with the light-emitting unit LED. The light emitted from the light-emitting unit LED can be projected upward through the light guide panel LGP, the shielding sheet SS, and the support plate hole SUPH of the support plate SUP. The light-emitting unit LED includes a package P and a light-emitting die D disposed inside the package P. The light-emitting unit LED may optionally include a coating layer W disposed or printed on the upper surface of the package P. The coating layer W is light-transmissive and serves to slightly enhance the brightness of the light-emitting unit LED. The coating layer W may be implemented by a white coating, while the package P may be made of a phosphor material. The light-emitting die D includes two electrodes E (positive and negative), which are electrically connected to the two footprints FP respectively via conductive materials Sn, such as solder paste or equivalent materials.

The light guide panel LGP of the backlight module BLM is disposed above the lighting board LCB. The light guide panel LGP includes a light guide hole L0, within which the light-emitting unit LED is positioned. The upper surface of the light guide panel LGP near the light guide hole L0 is provided with a top adhesive layer TA surrounding the hole L0 to bond the shielding sheet SS, while the lower surface of the light guide panel LGP near the light guide hole L0 is provided with a bottom adhesive layer BA to bond the reflective layer REF of the lighting board LCB. As shown in FIG. 7B, a region NA between the projection of the mask layer ML and the projection of the top adhesive layer TA/bottom adhesive layer BA is a non-adhesive region of respective upper and lower surfaces of the lighting board LCB, the light guide panel LGP, and the shielding sheet SS.

The shielding sheet SS of the backlight module BLM is disposed above the light guide panel LGP. The shielding sheet SS includes a mask layer ML, a reflective layer RL, and a translucent layer TL. The mask layer ML, the reflective layer RL, and the translucent layer TL may be stacked in various configurations. For example, any of these layers may be positioned on the top, middle, or bottom to form the shielding sheet SS. The mask layer ML is opaque. The reflective layer RL has both reflective and semi-transparent properties, meaning that it reflects part of the light while allowing a portion of the light to pass through. The translucent layer TL may be made of a light-transmissive material. The mask layer ML may be implemented by black ink, and the reflective layer RL may be implemented by white ink, but the present invention is not limited thereto. Since the shielding sheet SS is disposed above the light guide panel LGP, the upper surface of the light-emitting unit LED may be flush with or lower than the lower surface of the shielding sheet SS, allowing the shielding sheet SS to remain planar without being pushed into the support plate hole SUPH of the support plate SUP by the light-emitting unit LED.

The reflective layer REF of the lighting board LCB may include a reflective layer hole REFH. Since the open region (i.e., the reflective layer hole REFH) formed by die-cut lamination or printing process tends to have larger lamination and printing tolerances, the reflective layer hole REFH is designed with a larger aperture to avoid interference with the footprint FP. In this embodiment, as shown in FIGS. 7A to 7C, the reflective layer hole REFH overlaps in projection with the light-emitting unit LED in the Z direction, i.e., the light-emitting unit LED is aligned with the reflective layer hole REFH. Furthermore, a projection area of the reflective layer hole REFH in the Z direction is larger than that of the light-emitting unit LED (its package P). In other words, in a top view, a size of the light-emitting unit LED is smaller than an aperture of the reflective layer hole REFH.

However, although the embodiment shown in FIGS. 7A to 7C can solve the interference issue between the lighting board LCB and the footprint FP, it still has the following drawbacks: (1) the aperture of the reflective layer hole REFH is relatively large, thereby increasing an exposed area of the base B. Since the base B of the lighting board LCB is typically made of a low-reflective material, the increase of non-reflective area leads to a reduction in the lighting efficiency of the lighting keyboard; and (2) When the conductive material Sn is used to electrically connect the light-emitting unit LED to the circuit layer CL, the larger aperture of the reflective layer hole REFH allows the conductive material Sn to spread over the footprint FP, potentially causing misalignment of the light-emitting unit LED. In view of this, the following embodiments are provided to address and improve upon the aforementioned drawbacks.

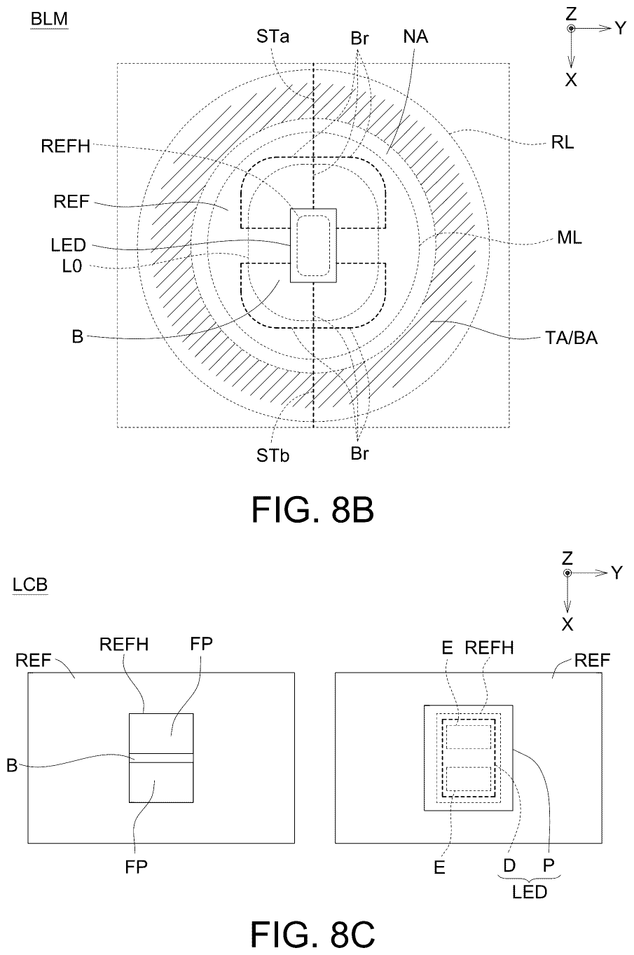

Please refer to FIGS. 8A to 8C. FIG. 8A is a partial top view illustrating another embodiment of a backlight module BLM of the lighting keyboard LKB of the present invention. FIG. 8B is a top view of the backlight module BLM in FIG. 8A, and FIG. 8C is a top view illustrating the lighting board LCB of the backlight module BLM of FIG. 8A. The left and right portions of FIG. 8C respectively illustrate the distinction between the presence and absence of the light-emitting unit LED.

As shown in FIGS. 8A to 8C, the lighting board LCB of the backlight module BLM includes a reflective layer REF, a circuit layer CL, and a base B. The reflective layer REF, the circuit layer CL and the base B are stacked from top to bottom, where the circuit layer CL is disposed on the base B, and the reflective layer REF is disposed on the circuit layer CL. The circuit layer CL includes two sub-traces STa and STb, and there is a footprint FP at the end of each of the two sub-traces STa/STb. Each footprint FP may be integrally formed with the sub-traces STa/STb by printing conductive wires or integrally formed with the sub-traces STa/STb by copper foil base etching process. However, each footprint FP may also be formed by overmolding process, or made of different material from that of the sub-traces STa/STb. As shown in FIG. 8B, each footprint FP has three branches Br, wherein the middle branch Br extends straight outward from an intersection point of the three branches Br (which overlaps in projection with the light-emitting unit LED vertically) to connect the sub-traces STa/STb. The remaining left and right two branches Br extend outward to form L-shaped paths to connect the sub-traces STa/STb.

The lighting board LCB is provided with the light-emitting unit LED. The light emitted from the light-emitting unit LED can be projected upward through the light guide panel LGP, the shielding sheet SS, and the support plate hole SUPH of the support plate SUP. The light-emitting unit LED includes a package P and a light-emitting die D disposed inside the package P. The light-emitting unit LED may optionally include a coating layer W disposed or printed on the upper surface of the package P. The coating layer W is light-transmissive and serves to slightly enhance the brightness of the light-emitting unit LED. The coating layer W may be implemented by a white coating, while the package P may be made of a phosphor material. The light-emitting die D includes two electrodes E (positive and negative), which are electrically connected to the two footprints FP respectively via conductive materials Sn, such as solder paste or equivalent materials.

The light guide panel LGP of the backlight module BLM is disposed above the lighting board LCB. The light guide panel LGP includes a light guide hole L0, within which the light-emitting unit LED is positioned. The upper surface of the light guide panel LGP near the light guide hole L0 is provided with a top adhesive layer TA surrounding the hole L0 to bond the shielding sheet SS, while the lower surface of the light guide panel LGP near the light guide hole L0 is provided with a bottom adhesive layer BA to bond the reflective layer REF of the lighting board LCB. As shown in FIG. 8B, a region NA between the projection of the mask layer ML and the projection of the top adhesive layer TA/bottom adhesive layer BA is a non-adhesive region of respective upper and lower surfaces of the lighting board LCB, the light guide panel LGP, and the shielding sheet SS.

The shielding sheet SS of the backlight module BLM is disposed above the light guide panel LGP. The shielding sheet SS includes a mask layer ML, a reflective layer RL, and a translucent layer TL. The mask layer ML, the reflective layer RL, and the translucent layer TL may be stacked in various configurations. For example, any of these layers may be positioned on the top, middle, or bottom to form the shielding sheet SS. The mask layer ML is opaque. The reflective layer RL has both reflective and semi-transparent properties, meaning that it reflects part of the light while allowing a portion of the light to pass through. The translucent layer TL may be made of a light-transmissive material. The mask layer ML may be implemented by black ink, and the reflective layer RL may be implemented by white ink, but the present invention is not limited thereto. Since the shielding sheet SS is disposed above the light guide panel LGP, the upper surface of the light-emitting unit LED may be flush with or lower than the lower surface of the shielding sheet SS, allowing the shielding sheet SS to remain planar without being pushed into the support plate hole SUPH of the support plate SUP by the light-emitting unit LED.

In this embodiment, the reflective layer REF of the light board LCB also has a reflective layer hole REFH. In order to improve drawbacks present in the embodiment shown in FIGS. 7A to 7C, as shown in FIGS. 8A to 8C, the reflective layer hole REFH overlaps in projection with the light-emitting unit LED in the Z direction, i.e., the light-emitting unit LED is aligned with the reflective layer hole REFH. Furthermore, a projection area of the reflective layer hole REFH in the Z direction is designed to be smaller than that of the light-emitting unit LED (its package P). In other words, in a top view, a size of the light-emitting unit LED is larger than an aperture of the reflective layer hole REFH. That is, the light-emitting unit LED covers the reflective layer hole REFH. Accordingly, the light emitted from the light-emitting unit LED toward the lighting board LCB will not reach the base B made of the low-reflective material, allowing the reflective region of the light emitted toward the lighting board LCB to increase, thereby effectively enhancing the lighting efficiency of the light-emitting keyboard LKB. Moreover, the upper surface of the reflective layer REF surrounding the reflective layer hole REFH/light-emitting unit LED can be provided with microstructures MS to strengthen the light reflection, further increasing the amount of light entering the light guide panel LGP.

Further, regarding some detailed configurations/designs of this embodiment, as shown in FIGS. 8A to 8C, the two projections of the two electrodes E of the light-emitting die D in the Z-direction are located within the projection area of the reflective layer hole REFH; the two projections of the two electrodes E of the light-emitting die D in the Z-direction are respectively located within the projection area of the two footprints FP of the circuit layer CL; the projection area of the light-emitting die D in the Z-direction is smaller than that of the reflective layer hole REFH (while the projection area of the package P in the Z-direction is larger than that of the reflective layer hole REFH); and/or the projection area of the light guide hole L0 of the light guide panel LGP is larger than that of the reflective layer hole REFH.

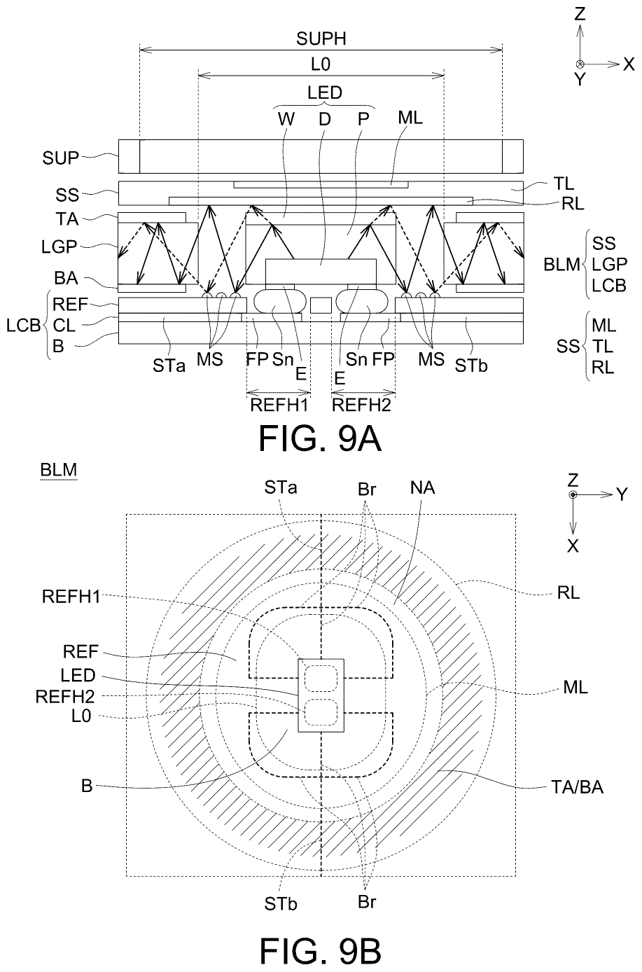

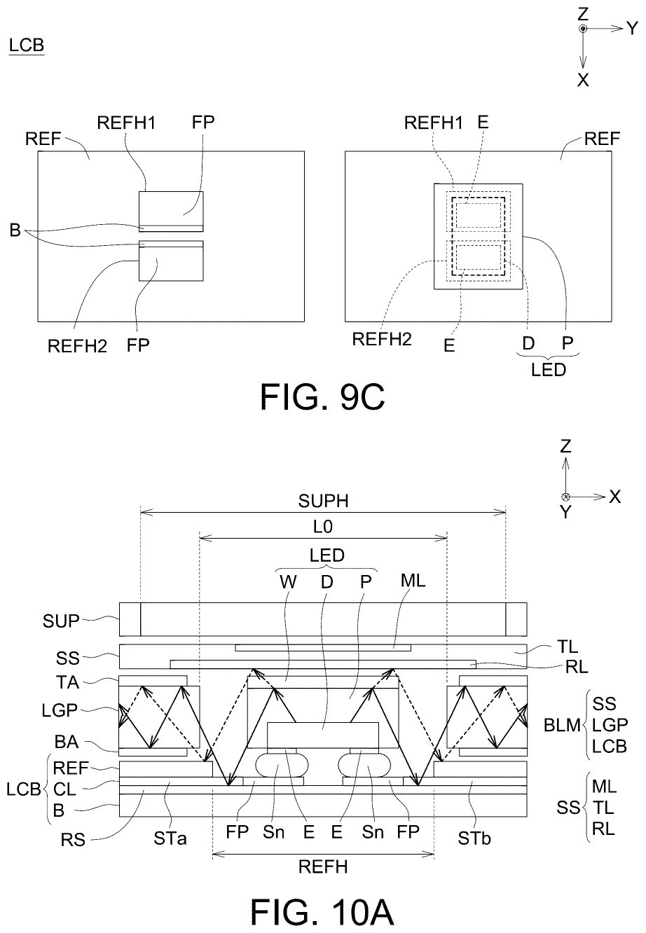

Please refer to FIGS. 9A to 9C. FIG. 9A is a partial top view illustrating another embodiment of a backlight module BLM of the lighting keyboard LKB of the present invention. FIG. 9B is a top view of the backlight module BLM in FIG. 9A, and FIG. 9C is a top view illustrating the lighting board LCB of the backlight module BLM of FIG. 9A. The left and right portions of FIG. 9C respectively illustrate the distinction between the presence and absence of the light-emitting unit LED.

As shown in FIGS. 9A to 9C, the lighting board LCB of the backlight module BLM includes a reflective layer REF, a circuit layer CL, and a base B. The reflective layer REF, the circuit layer CL and the base B are stacked from top to bottom, where the circuit layer CL is disposed on the base B, and the reflective layer REF is disposed on the circuit layer CL. The circuit layer CL includes two sub-traces STa and STb, and there is a footprint FP at the end of each of the two sub-traces STa/STb. Each footprint FP may be integrally formed with the sub-traces STa/STb by printing conductive wires or integrally formed with the sub-traces STa/STb by copper foil base etching process. However, each footprint FP may also be formed by overmolding process, or made of different material from that of the sub-traces STa/STb. As shown in FIG. 9B, each footprint FP has three branches Br, wherein the middle branch Br extends straight outward from an intersection point of the three branches Br (which overlaps in projection with the light-emitting unit LED vertically) to connect the sub-traces STa/STb. The remaining left and right two branches Br extend outward to form L-shaped paths to connect the sub-traces STa/STb.

The lighting board LCB is provided with the light-emitting unit LED. The light emitted from the light-emitting unit LED can be projected upward through the light guide panel LGP, the shielding sheet SS, and the support plate hole SUPH of the support plate SUP. The light-emitting unit LED includes a package P and a light-emitting die D disposed inside the package P. The light-emitting unit LED may optionally include a coating layer W disposed or printed on the upper surface of the package P. The coating layer W is light-transmissive and serves to slightly enhance the brightness of the light-emitting unit LED. The coating layer W may be implemented by a white coating, while the package P may be made of a phosphor material. The light-emitting die D includes two electrodes E (positive and negative), which are electrically connected to the two footprints FP respectively via conductive materials Sn, such as solder paste or equivalent materials.

The light guide panel LGP of the backlight module BLM is disposed above the lighting board LCB. The light guide panel LGP includes a light guide hole L0, within which the light-emitting unit LED is positioned. The upper surface of the light guide panel LGP near the light guide hole L0 is provided with a top adhesive layer TA surrounding the hole L0 to bond the shielding sheet SS, while the lower surface of the light guide panel LGP near the light guide hole L0 is provided with a bottom adhesive layer BA to bond the reflective layer REF of the lighting board LCB. As shown in FIG. 9B, a region NA between the projection of the mask layer ML and the projection of the top adhesive layer TA/bottom adhesive layer BA is a non-adhesive region of respective upper and lower surfaces of the lighting board LCB, the light guide panel LGP, and the shielding sheet SS.

The shielding sheet SS of the backlight module BLM is disposed above the light guide panel LGP. The shielding sheet SS includes a mask layer ML, a reflective layer RL, and a translucent layer TL. The mask layer ML, the reflective layer RL, and the translucent layer TL may be stacked in various configurations. For example, any of these layers may be positioned on the top, middle, or bottom to form the shielding sheet SS. The mask layer ML is opaque. The reflective layer RL has both reflective and semi-transparent properties, meaning that it reflects part of the light while allowing a portion of the light to pass through. The translucent layer TL may be made of a light-transmissive material. The mask layer ML may be implemented by black ink, and the reflective layer RL may be implemented by white ink, but the present invention is not limited thereto. Since the shielding sheet SS is disposed above the light guide panel LGP, the upper surface of the light-emitting unit LED may be flush with or lower than the lower surface of the shielding sheet SS, allowing the shielding sheet SS to remain planar without being pushed into the support plate hole SUPH of the support plate SUP by the light-emitting unit LED.

In this embodiment, the reflective layer REF of the light board LCB has two reflective layer holes, namely a first reflective layer hole REFH1 and a second reflective layer hole REFH2. In order to improve drawbacks present in the embodiment shown in FIGS. 7A to 7C, as shown in FIGS. 9A to 9C, the first reflective layer hole REFH1 and the second reflective layer hole REFH2 overlap in projection with the light-emitting unit LED in the Z direction, i.e., the light-emitting unit LED is aligned with the first reflective layer hole REFH1 and the second reflective layer hole REFH2. Furthermore, a projection area of the first reflective layer hole REFH1 and a projection area of the second reflective layer hole REFH2 in the Z direction are designed to be smaller than that of the light-emitting unit LED (its package P). In other words, in a top view, a size of the light-emitting unit LED is larger than an aperture of the first reflective layer hole REFH1 and an aperture of the second reflective layer hole REFH2. That is, the light-emitting unit LED covers the first reflective layer hole REFH1 and the second reflective layer hole REFH2. Accordingly, the light emitted from the light-emitting unit LED toward the lighting board LCB will not reach the base B made of the low-reflective material, allowing the reflective region of the light emitted toward the lighting board LCB to increase, thereby effectively enhancing the lighting efficiency of the light-emitting keyboard LKB. Moreover, the upper surface of the reflective layer REF surrounding the reflective layer hole REFH/light-emitting unit LED can be provided with microstructures MS to strengthen the light reflection, further increasing the amount of light entering the light guide panel LGP. On the other hand, the dual-aperture design of the reflective layer REF in this embodiment can further separately confine the flow of the two conductive materials Sn, thereby preventing any positional shift of the light-emitting unit LED and thus improving the positioning accuracy of the light-emitting unit LED.

Further, regarding some detailed configurations/designs of this embodiment, as shown in FIGS. 9A to 9C, the two projections of the two electrodes E of the light-emitting die D in the Z-direction are respectively located within the projection area of the first reflective layer hole REFH1 and the projection area of the second reflective layer hole REFH2; the two projections of the two electrodes E of the light-emitting die D in the Z-direction are respectively located within the projection areas of the two footprints FP of the circuit layer CL; the two conductive materials Sn are respectively located in the first reflective layer hole REFH1 and the second reflective layer hole REFH2; and/or the projection area of the light guide hole L0 of the light guide panel LGP is larger than those of the first reflective layer hole REFH1 and the second reflective layer hole REFH2.

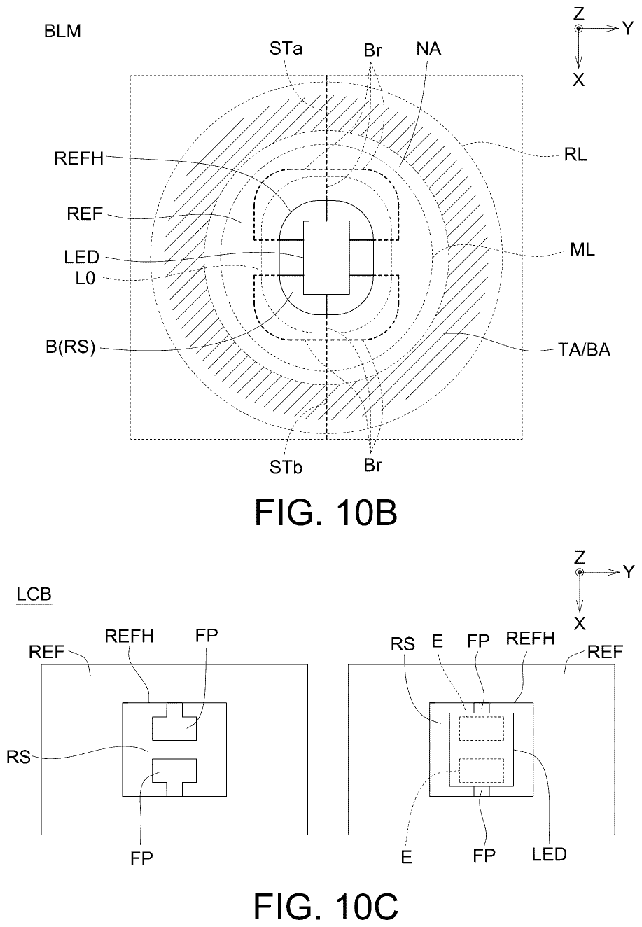

Please refer to FIGS. 10A to 10C. FIG. 10A is a partial top view illustrating another embodiment of a backlight module BLM of the lighting keyboard LKB of the present invention. FIG. 10B is a top view of the backlight module BLM in FIG. 10A, and FIG. 10C is a top view illustrating the lighting board LCB of the backlight module BLM of FIG. 10A. The left and right portions of FIG. 10C respectively illustrate the distinction between the presence and absence of the light-emitting unit LED.

As shown in FIGS. 10A to 10C, the lighting board LCB of the backlight module BLM includes a reflective layer REF, a circuit layer CL, and a base B. The reflective layer REF, the circuit layer CL and the base B are stacked from top to bottom, where the circuit layer CL is disposed on the base B, and the reflective layer REF is disposed on the circuit layer CL. The circuit layer CL includes two sub-traces STa and STb, and there is a footprint FP at the end of each of the two sub-traces STa/STb. Each footprint FP may be integrally formed with the sub-traces STa/STb by printing conductive wires or integrally formed with the sub-traces STa/STb by copper foil substrate etching process. However, each footprint FP may also be formed by overmolding process, or made of different material from that of the sub-traces STa/STb. As shown in FIG. 10B, each footprint FP has three branches Br, wherein the middle branch Br extends straight outward from an intersection point of the three branches Br (which overlaps in projection with the light-emitting unit LED vertically) to connect the sub-traces STa/STb. The remaining left and right two branches Br extend outward to form L-shaped paths to connect the sub-traces STa/STb.

The lighting board LCB is provided with the light-emitting unit LED. The light emitted from the light-emitting unit LED can be projected upward through the light guide panel LGP, the shielding sheet SS, and the support plate hole SUPH of the support plate SUP. The light-emitting unit LED includes a package P and a light-emitting die D disposed inside the package P. The light-emitting unit LED may optionally include a coating layer W disposed or printed on the upper surface of the package P. The coating layer W is light-transmissive and serves to slightly enhance the brightness of the light-emitting unit LED. The coating layer W may be implemented by a white coating, while the package P may be made of a phosphor material. The light-emitting die D includes two electrodes E (positive and negative), which are electrically connected to the two footprints FP respectively via conductive materials Sn, such as solder paste or equivalent materials.

The light guide panel LGP of the backlight module BLM is disposed above the lighting board LCB. The light guide panel LGP includes a light guide hole L0, within which the light-emitting unit LED is positioned. The upper surface of the light guide panel LGP near the light guide hole L0 is provided with a top adhesive layer TA surrounding the hole L0 to bond the shielding sheet SS, while the lower surface of the light guide panel LGP near the light guide hole L0 is provided with a bottom adhesive layer BA to bond the reflective layer REF of the lighting board LCB. As shown in FIG. 10B, a region NA between the projection of the mask layer ML and the projection of the top adhesive layer TA/bottom adhesive layer BA is a non-adhesive region of respective upper and lower surfaces of the lighting board LCB, the light guide panel LGP, and the shielding sheet SS.

The shielding sheet SS of the backlight module BLM is disposed above the light guide panel LGP. The shielding sheet SS includes a mask layer ML, a reflective layer RL, and a translucent layer TL. The mask layer ML, the reflective layer RL, and the translucent layer TL may be stacked in various configurations. For example, any of these layers may be positioned on the top, middle, or bottom to form the shielding sheet SS. The mask layer ML is opaque. The reflective layer RL has both reflective and semi-transparent properties, meaning that it reflects part of the light while allowing a portion of the light to pass through. The translucent layer TL may be made of a light-transmissive material. The mask layer ML may be implemented by black ink, and the reflective layer RL may be implemented by white ink, but the present invention is not limited thereto. Since the shielding sheet SS is disposed above the light guide panel LGP, the upper surface of the light-emitting unit LED may be flush with or lower than the lower surface of the shielding sheet SS, allowing the shielding sheet SS to remain planar without being pushed into the support plate hole SUPH of the support plate SUP by the light-emitting unit LED.

The reflective layer REF of the light board LCB has a reflective layer hole REFH. In this embodiment, as shown in FIGS. 10A to 10C, the reflective layer hole REFH overlaps in projection with the light-emitting unit LED in the Z direction, i.e., the light-emitting unit LED is aligned with the reflective layer hole REFH. As in the embodiment illustrated in FIGS. 7A to 7C, furthermore, a projection area of the light-emitting unit LED (its package P) in the Z direction is smaller than that of the reflective layer hole REFH. In other words, in a top view, a size of the light-emitting unit LED is smaller than an aperture of the reflective layer hole REFH.

In order to improve drawbacks present in the embodiment shown in FIGS. 7A to 7C, as shown in FIGS. 10A to 10C, a reflective surface RS with light-reflecting property is formed on an upper surface of the base B. The reflective surface RS is exposed through the reflective layer hole REFH. Accordingly, by implementing a design improvement on the base B so that its upper surface has high reflectivity, the light emitted from the light-emitting unit LED toward the lighting board LCB and reaching the base B can also be reflected by the reflective surface RS and thereby enter the light guide panel LGP for lateral propagation. As a result, the reflective region for the light emitted from the light-emitting unit LED toward the lighting board LCB is increased, thereby effectively enhancing the light-emitting efficiency of the lighting keyboard LKB. In this embodiment, the base B is designed to include a reflective coating, and the reflective surface RS is the upper surface of this reflective coating. The reflective surface RS may be implemented, for example, by applying a white ink coating onto the base B. In other feasible embodiments, the upper surface of the base B itself is the reflective surface RS, meaning that the base B itself may be made of a white material to achieve this function. Therefore, the embodiment illustrated in FIGS. 10A to 10C can improve the shortcomings of the embodiment shown in FIGS. 10A to 10C merely by modifying the base B, without requiring any change to the aperture size of the reflective layer hole REFH. This design accordingly reduces manufacturing cost.

Further, regarding some detailed configurations/designs of this embodiment, as shown in FIGS. 10A to 10C, the two projections of the two electrodes E of the light-emitting die D in the Z-direction are located within the projection area of the reflective layer hole REFH; the two projections of the two electrodes E of the light-emitting die D in the Z-direction are respectively located within the projection area of the two footprints FP of the circuit layer CL; the projection area of the light-emitting die D in the Z-direction is smaller than that of the reflective layer hole REFH; and/or the projection area of the light guide hole L0 of the light guide panel LGP is larger than that of the reflective layer hole REFH.

Those skilled in the art will readily observe that numerous modifications and alterations of the device and method may be made while retaining the teachings of the invention.

Accordingly, the above disclosure should be construed as limited only by the metes and bounds of the appended claims.

What is claimed is:

1. A backlight module, comprising:
a lighting board including a reflective layer, a circuit layer and a base that are stacked from top to bottom, wherein the reflective layer has a reflective layer hole;
wherein, the lighting board includes a light-emitting unit, the light-emitting unit includes a package and a light-emitting die disposed inside the package, the reflective layer hole overlaps in projection with the light-emitting unit in a vertical direction, and a projection area of the reflective layer hole in the vertical direction is smaller than a projection area of the package in the vertical direction.

2. The backlight module according to claim 1, wherein the light-emitting die includes two electrodes, the circuit layer has two footprints, the two electrodes are electrically connected to the two footprints respectively via two conductive materials, two projections of the two electrodes in the vertical direction are located within a projection area of the reflective layer hole in the vertical direction.

3. The backlight module according to claim 1, wherein the light-emitting die include two electrodes, the circuit layer has two footprints, the two electrodes are electrically connected to the two footprints respectively via two conductive materials, and two projections of the two electrodes in the vertical direction are respectively located within two projection areas of the two footprints in the vertical direction.

4. The backlight module according to claim 1, wherein a projection area of the light-emitting die in the vertical direction is smaller than a projection area of the reflective layer hole in the vertical direction.

5. The backlight module according to claim 1, further comprising:
a light guide panel disposed above the lighting board, wherein the light guide panel has a light guide hole, the light-emitting unit is disposed in the light guide hole, wherein a projection area of the light guide hole in the vertical direction is larger than a projection area of the reflective layer hole in the vertical direction.

6. A backlight module, comprising:
a lighting board including a reflective layer, a circuit layer and a base that are stacked from top to bottom, wherein the reflective layer has a first reflective layer hole and a second reflective layer hole;
wherein, the lighting board includes a light-emitting unit, the light-emitting unit includes a package and a light-emitting die disposed inside the package, the first reflective layer hole and the second reflective layer hole overlap in projection with the light-emitting unit in a vertical direction, and a projection area of the reflective layer hole in the vertical direction and a projection area of the reflective layer hole in the vertical direction are respectively smaller than a projection area of the package in the vertical direction.

7. The backlight module according to claim 6, wherein the light-emitting die includes two electrodes, the circuit layer has two footprints, the two electrodes are electrically connected to the two footprints respectively via two conductive materials, two projections of the two electrodes in the vertical direction are located within a projection area of the reflective layer hole in the vertical direction.

8. The backlight module according to claim 6, wherein the light-emitting die include two electrodes, the circuit layer has two footprints, the two electrodes are electrically connected to the two footprints respectively via two conductive materials, and two projections of the two electrodes in the vertical direction are respectively located within two projection areas of the two footprints in the vertical direction.

9. The backlight module according to claim 7, wherein the two conductive materials are respectively disposed in the first reflective layer hole and the second reflective layer hole.

10. The backlight module according to claim 8, wherein the two conductive materials are respectively disposed in the first reflective layer hole and the second reflective layer hole.

11. The backlight module according to claim 6, further comprising:
a light guide panel disposed above the lighting board, wherein the light guide panel has a light guide hole, the light-emitting unit is disposed in the light guide hole, wherein a projection area of the light guide hole in the vertical direction is larger than a projection area of the first reflective layer hole in the vertical direction and a projection area of the second reflective layer hole in the vertical direction.

12. A backlight module, comprising:
a lighting board including a reflective layer, a circuit layer and a base that are stacked from top to bottom, wherein the reflective layer has a reflective layer hole, a reflective surface with light-reflecting property is formed on an upper surface of the base, and the reflective surface is exposed through the reflective layer hole;
wherein, the lighting board includes a light-emitting unit, the light-emitting unit includes a package and a light-emitting die disposed inside the package, the light-emitting unit hole overlaps in projection with the reflective layer in a vertical direction, a projection area of the package in the vertical direction is smaller than a projection area of the reflective layer hole in the vertical direction.

13. The backlight module according to claim 12, wherein the base includes a reflective coating, the reflective surface is an upper surface of the reflective coating.

14. The backlight module according to claim 12, wherein an upper surface of the base itself is the reflective surface.

15. The backlight module according to claim 12, wherein the light-emitting die includes two electrodes, the circuit layer has two footprints, the two electrodes are electrically connected to the two footprints respectively via two conductive materials, two projections of the two electrodes in the vertical direction are located within a projection area of the reflective layer hole in the vertical direction.

16. The backlight module according to claim 12, wherein the light-emitting die include two electrodes, the circuit layer has two footprints, the two electrodes are electrically connected to the two footprints respectively via two conductive materials, and two projections of the two electrodes in the vertical direction are respectively located within two projection areas of the two footprints in the vertical direction.

17. The backlight module according to claim 12, wherein a projection area of the light-emitting die in the vertical direction is smaller than a projection area of the reflective layer hole in the vertical direction.

18. The backlight module according to claim 12, further comprising:
a light guide panel disposed above the lighting board, wherein the light guide panel has a light guide hole, the light-emitting unit is disposed in the light guide hole, wherein a projection area of the light guide hole in the vertical direction is larger than a projection area of the reflective layer hole in the vertical direction.
